(19) United States
(12) Patent Application Publication
(10) Pub. No.: US 2015/0046024 A1
(43) Pub. Date: Feb. 12, 2015

(54) Vehicle and Texting Monitoring Device

(71) Applicant: Charles Harbison, III, Charlotte, NC (US)

(72) Inventor: Charles Harbison, III, Charlotte, NC (US)

(21) Appl. No.: 14/303,686

(22) Filed: Jun. 13, 2014

Related U.S. Application Data
(60) Provisional application No. 61/863,306, filed on Aug. 7, 2013.

(51) Int. Cl. G07C 5/08; H04W 4/04; B60C 23/04; H04L 29/08

(52) U.S. Cl. CPC G07C 5/0808; H04L 67/12; H04W 4/046; B60C 23/0481
USPC 701/33.2

(57) ABSTRACT

A vehicle and texting monitoring device communicates with an on board diagnostics port of a vehicle, a phone in the vehicle, and a remote electronic device to permit remote monitoring of vehicle conditions and texting within the vehicle while the vehicle is being operated. The device includes a housing and a processor coupled to and positioned in the housing. A connector is configured for coupling to a digital communications port of a vehicle wherein the processor is communicatively coupled to a plurality of subsystems of the vehicle. A transceiver is communicatively coupled to the processor wherein the transceiver transmits data to and from the processor wherein the transceiver defines a communications gateway between the processor and the vehicle, a phone positioned in the vehicle, and an extrinsic electronic device. Thus, the extrinsic electronic device monitors functional aspects of the vehicle and use of the phone positioned in the vehicle.

### CROSS-REFERENCE TO RELATED APPLICATIONS

This application claims benefit from provisional application 61/863,306 filed on Aug. 7, 2013.

### BACKGROUND OF THE DISCLOSURE

### Field of the Disclosure

The disclosure relates to monitoring devices and more particularly pertains to a new monitoring device for communicating with an on board diagnostics port of a vehicle, a phone in the vehicle, and a remote electronic device to permit remote monitoring of vehicle conditions and texting within the vehicle while the vehicle is being operated.

### SUMMARY OF THE DISCLOSURE

An embodiment of the disclosure meets the needs presented above by generally comprising a housing and a processor coupled to and positioned in the housing. A connector is configured for coupling to a digital communications port of a vehicle wherein the processor is communicatively coupled to a plurality of subsystems of the vehicle. A transceiver is communicatively coupled to the processor wherein the transceiver transmits data to and from the processor wherein the transceiver defines a communications gateway between the processor and the vehicle, a phone positioned in the vehicle, and an extrinsic electronic device. Thus, the extrinsic electronic device monitors functional aspects of the vehicle and use of the phone positioned in the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a vehicle and texting monitoring device according to an embodiment of the disclosure.

FIG. 2 is a side view of an embodiment of the disclosure in use.

FIG. 3 is a schematic view of an embodiment of the disclosure.

### DESCRIPTION OF THE PREFERRED EMBODIMENT

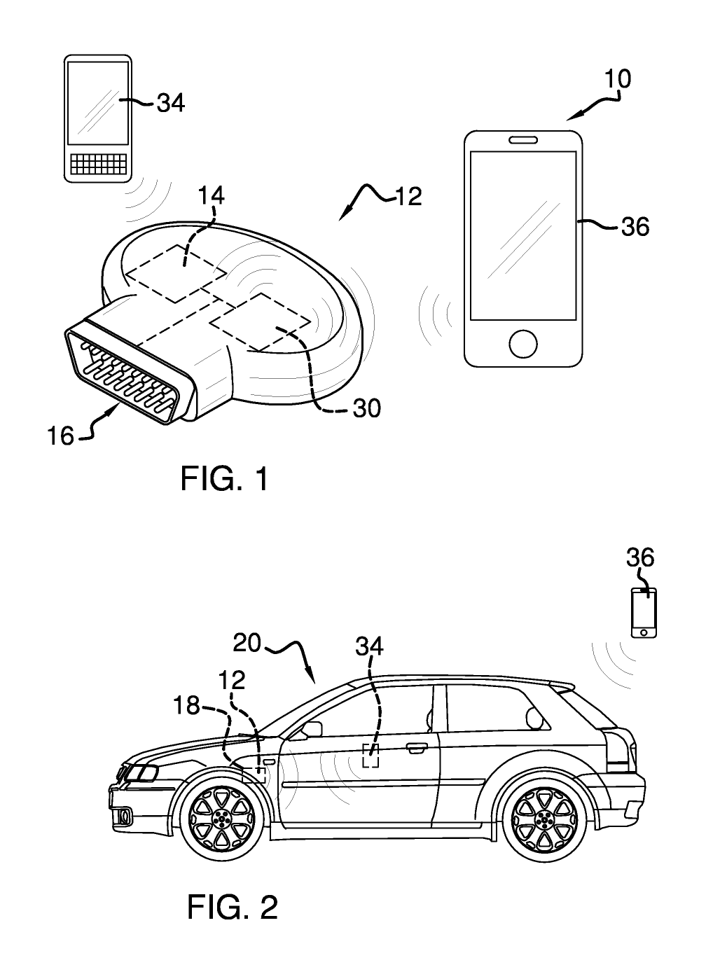

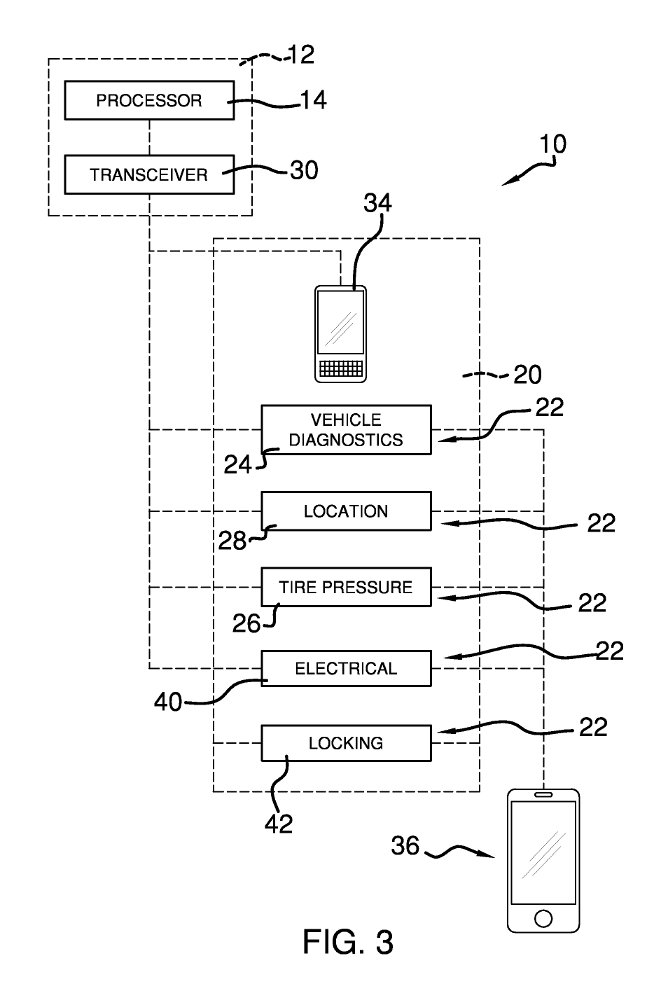

With reference now to the drawings, and in particular to FIGS. 1 through 3 thereof, a new monitoring device embodying the principles and concepts of an embodiment of the disclosure and generally designated by the reference numeral 10 will be described.

As best illustrated in FIGS. 1 through 3, the vehicle and texting monitoring device 10 generally comprises a housing 12. A processor 14 is coupled to and is positioned in the housing 12. A connector 16 is configured for coupling to a digital communications port 18 of a vehicle 20 wherein the processor 14 is communicatively coupled to a plurality of subsystems 22 of the vehicle 20. The vehicle subsystems 22 include but need not be limited to a diagnostics subsystem 24, a tire pressure monitoring subsystem 26, and a global positioning subsystem 28. The connector 16 may be an on board diagnostics type 2 connector to connect to an existing port on the vehicle 20 and facilitate connection to the diagnostics subsystem 24 of the vehicle 20. A transceiver 30 is communicatively coupled to the processor 14 wherein the transceiver 30 transmits data to and from the processor 14. Thus, the transceiver 30 defines a communications gateway 32 between the processor 14 and the vehicle 20, a phone 34 positioned in the vehicle 20, and an extrinsic electronic device 36 relative to the vehicle 20 such that the extrinsic electronic device 36 monitors functional aspects of the vehicle 20 and use of the phone 34 positioned in the vehicle 20. This allows a person operating the extrinsic electronic device 36, such as a cellular phone, an electronic tablet, laptop computer, or the like, to check the condition of the vehicle 20 and be alerted to unsafe conditions relating to the condition of the vehicle 20 or operation of the phone 34 while operating the vehicle 20.

The processor 14 is programmed to interface with the diagnostic subsystem 24, the tire pressure monitoring subsystem 26, and the global positioning subsystem 28 wherein a position of the vehicle 20 is communicated to the extrinsic electronic device 36. Reporting of the position of the vehicle 20 may be provided in real time or on demand responsive to a command from either the phone 34 or the extrinsic electronic device 36. The processor 14 is programmed to interface with the phone 34 positioned in the vehicle 20 wherein use of the phone 34 while positioned in the vehicle 20 is communicated to the extrinsic device 36. Thus, a parent or other person may use the extrinsic electronic device 36 to be assured a child is not using the phone 34 while operating the vehicle 20. The processor 14 is also programmed to identify and transmit diagnostic codes related to vehicle condition warning signals, such as “check engine” or the like, to the extrinsic electronic device 36. The processor 14 may be further programmed to transmit a definition of the diagnostic code transmitted to the extrinsic electronic device 36 to provide more specific explanation as to why a particular diagnostic code has been generated. Thus, the parent may be assured the vehicle 20 is and continues to be in proper working condition while being used by the child. When provided with the vehicle 20, the tire pressure monitoring subsystem 26 to allow remote monitoring of the tire pressure of the vehicle 20. The processor 14 may also be programmed to interface with an electrical subsystem 40 of the vehicle 20 to monitor proper charge of a battery and proper charging of the battery during use of the vehicle 20. The processor 14 may also be interactively coupled to a locking subsystem 42 of the vehicle 20 to permit remote locking or unlocking of the vehicle 20 using the extrinsic electronic device 36.

In use, the housing 12 is installed on the vehicle 20 by coupling the connector 16 to the digital communications port 18 of the vehicle 20. The transceiver 30 and processor 14 establish communications with the phone 34 in the vehicle 20 and the extrinsic electronic device 36. As described above, the processor 14 facilitates monitoring of and interaction with the subsystems 22 of the vehicle 20 and use of the phone 34, or multiple phones 34, within the vehicle 20 while the vehicle 20 is being operated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle and texting monitoring device comprising:
a housing;
a processor coupled to and being positioned in said housing;
a connector configured for coupling to a digital communications port of a vehicle wherein said processor is communicatively coupled to a plurality of subsystems of the vehicle; and
a transceiver communicatively coupled to said processor wherein said transceiver transmits data to and from said processor wherein said transceiver defines a communications gateway between said processor and the vehicle, a phone positioned in the vehicle, and an extrinsic electronic device wherein said extrinsic electronic device monitors functional aspects of the vehicle and use of the phone positioned in the vehicle.

2. The device of claim 1, further comprising said connector being an on board diagnostics type 2 connector.

3. The device of claim 1, further comprising said vehicle subsystems including a diagnostics subsystem, said processor being programmed to interface with said diagnostic subsystem.

4. The device of claim 1, further comprising said vehicle subsystems including a tire pressure monitoring subsystem, said processor being programmed to interface with said tire pressure monitoring subsystem.

5. The device of claim 1, further comprising said vehicle subsystems including a global positioning subsystem, said processor being programmed to interface with said global positioning subsystem wherein a position of the vehicle is communicated to the extrinsic electronic device.

6. The device of claim 1, further comprising said processor being programmed to interface with the phone positioned in the vehicle wherein use of the phone while positioned in the vehicle is communicated to the extrinsic device.

7. The device of claim 2, further comprising said processor being programmed to identify and transmit diagnostic codes related to vehicle condition warning signals to the extrinsic electronic device.

8. The device of claim 7, further comprising said processor being programmed to transmit a definition of said diagnostic code transmitted to the extrinsic electronic device.

9. A vehicle and texting monitoring device comprising:
a housing;
a processor coupled to and being positioned in said housing;
a connector configured for coupling to a digital communications port of a vehicle wherein said processor is communicatively coupled to a plurality of subsystems of the vehicle, said vehicle subsystems including a diagnostics subsystem, a tire pressure monitoring subsystem, and a global positioning subsystem, said connector being an on board diagnostics type 2 connector;
a transceiver communicatively coupled to said processor wherein said transceiver transmits data to and from said processor wherein said transceiver defines a communications gateway between said processor and the vehicle, a phone positioned in the vehicle, and an extrinsic electronic device wherein said extrinsic electronic device monitors functional aspects of the vehicle and use of the phone positioned in the vehicle; and
said processor being programmed to interface with said diagnostic subsystem, said processor being programmed to interface with said tire pressure monitoring subsystem, said processor being programmed to interface with said global positioning subsystem wherein a position of the vehicle is communicated to the extrinsic electronic device, said processor being programmed to interface with the phone positioned in the vehicle wherein use of the phone while positioned in the vehicle is communicated to the extrinsic device, said processor being programmed to identify and transmit diagnostic codes related to vehicle condition warning signals to the extrinsic electronic device, said processor being programmed to transmit a definition of said diagnostic code transmitted to the extrinsic electronic device.
